(19) United States
(12) Patent Application Publication
(10) Pub. No.: US 2008/0151286 A1
(43) Pub. Date: Jun. 26, 2008

(54) INFORMATION PROCESSING DEVICE, CONTROL METHOD FOR INFORMATION PROCESSING DEVICE, OUTPUT PROCESSING SYSTEM, AND PROGRAM RECORDING MEDIUM

(76) Inventor: Yoshie MATSUO, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 11/765,555

(22) Filed: Jun. 20, 2007

(30) Foreign Application Priority Data
Dec. 21, 2006 (JP) 2006-343884

(51) Int. Cl. G06F 3/12

(52) U.S. Cl. 358/1.15

(57) ABSTRACT

A print server (10) stores job data received from a client device (20), stores permission information describing whether or not output of the job data is permitted with respect to a user that owns the job data and a representative of the user. Then, when identification information identifying at least one user and a request to output the stored job data are received from the printer (30), the print server (10) searches for job data from the job data stored, the job data permitted to be output to the user identified by the identification information, and transfers the job data searched for to the printer (30).

### CROSS-REFERENCE TO RELATED APPLICATIONS

This application is based on and claims priority under 35 U.S.C. 119 from Japanese Patent Application No. 2006-343884 filed on Dec. 21, 2006.

### BACKGROUND

1. Technical Field

The present invention relates to an information processing device, a control method for the information processing device, an output processing system, and a program recording medium.

2. Related Art

There are available print systems in which process data, such as a print job, or the like, is temporarily stored in a print server before being transferred to a printer in response to a request from the printer, rather than being directly provided to the printer. In some of the print systems of this type, the printer authenticates the user so that the printer server collectively provides the printer with print jobs belonging to the authenticated user. Ensured security with the output processing system, such as a print system, or the like, while improving the usability thereof, is required.

### SUMMARY

According to one aspect of the present invention, there is provided an information processing device including the following.

An information processing device, comprising a storage unit that stores job data to be processed, a permission information memory that stores, for every item of the job data stored in the storage unit, permission information describing whether or not output of the job data is permitted with respect to a user that owns the job data and a representative of the user, a search unit that searches, when receiving from a device a request to output the job data stored in the storage unit and user identification information identifying a user, for job data permitted to be output by the user based on the user identification information and the permission information, and a transfer unit that transfers the job data searched for by the search unit to the device.

### BRIEF DESCRIPTION OF THE DRAWINGS

Exemplary embodiments of the present invention will be described in detail based on the following figures, wherein:

FIG. 1 is a diagram showing a structure of a print system;

FIG. 2 is a block diagram illustrating functions of a print server;

FIG. 3 is a diagram showing one example of a representative setting table;

FIGS. 4A and 4B are diagrams showing one example of a print information table;

FIG. 5 is a diagram illustrating a sequence of a process to output print data, the process being carried out in the print system; and

FIGS. 6A and 6B are diagram showing one example of the print information table and an entry/leaving information of the user.

### DETAILED DESCRIPTION

In the following, an exemplary embodiment for putting the present invention into practice (hereinafter referred to as an exemplary embodiment) will be described with reference to the accompanying drawings.

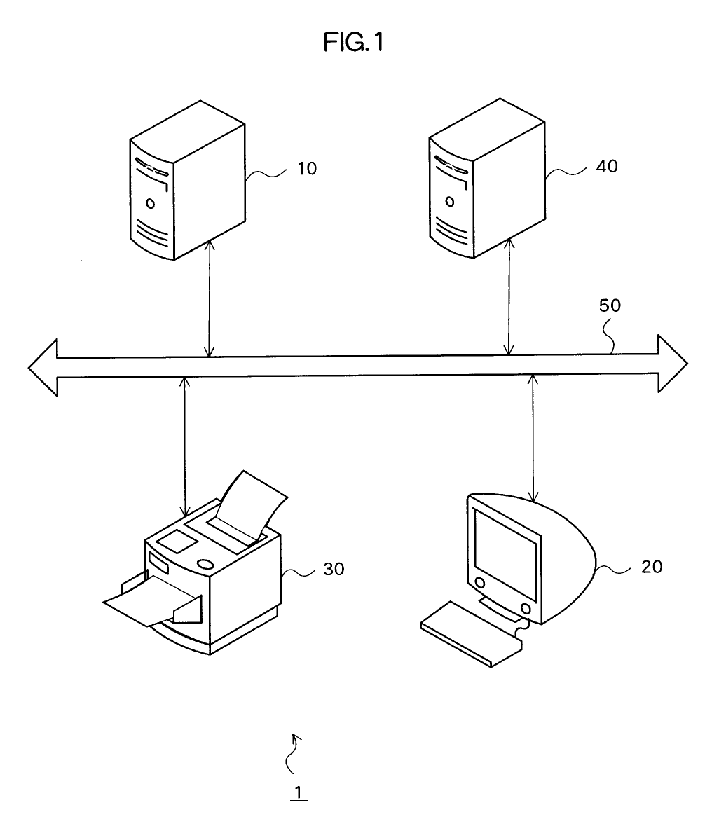

FIG. 1 is a diagram showing a structure of a print system 1 according to this exemplary embodiment. As shown in FIG. 1, the print system 1 includes a client device 20, a print server 10, a printer 30, and an authentication server 40, which communicate with each other via a network 50.

The client device 20 is a terminal device for a user operation, and specifically, in response to a print instruction by the user, produces print data based on application data, or the like, and transmits the produced print data to the print server 10.

The print server 10 is an information processing device for processing print data, or an object to be processed by the print system 1. Specifically, the print server 10 manages the print data received from the client device 20, together with the information about a user who is the owner of the print data and a user who is a representative of the owner, and stores the information about whether or not output of the print data via the printer 30 is permitted with respect to each of the owner and the representative of the owner. Details of the representative and the print data information management will be described later.

The print server 10 receives from the printer 30 the information about the authenticated user and a print data transfer request, and operates as follows. That is, the print server 10 searches for, and retrieves, print data which is owned or represented by, and permitted to be output to, the authenticated user, and then transfers the retrieved print data to the printer 30.

The printer 30 forms and outputs an image based on the print data. Specifically, the printer 30 requests the authentication server 40 to authentication the user based on the input user information, and with the user successfully authenticated by the authentication server 40, then requests the print server 10 to provide print data permitted to be output to the authenticated user. The printer 30 receives the print data which is sent from the print server 10 in response to the request, then forms an image based on the received print data on a print sheet, and outputs the image.

In the following, an example of a structure of the print server 10 to realize the above-described process will be described.

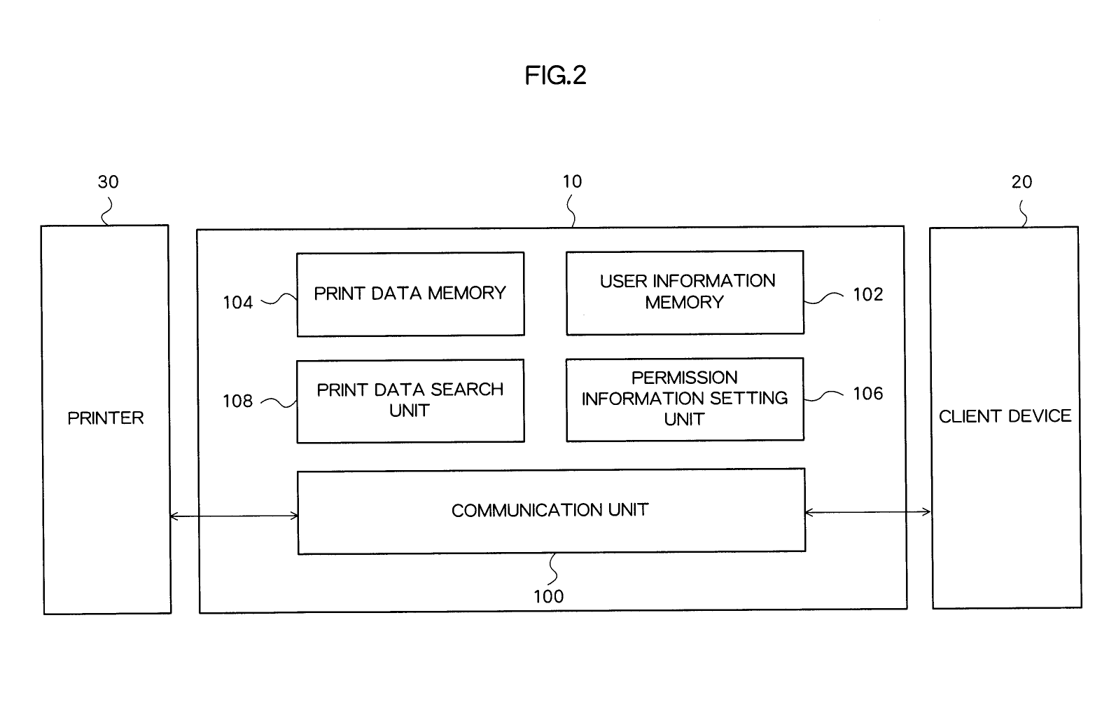

FIG. 2 is a block diagram illustrating functions of the print server 10. As shown in FIG. 2, the print server 10 includes, as a functional structure, a communication unit 100, a user information memory 102, a print data memory 104, a permission information setting unit 106, and a print data search unit 108. The respective units are realized using general hardware, such as a CPU (central processing unit), a memory, a network interface (NIC), or the like, which constitute a computer system.

The communication unit 100 is realized using a NIC, for example, and communicates with other information communication device using the TCP/IP protocol. The user information memory 102 and the print data memory 104 are realized using a memory unit (including a RAM, a ROM, or the like), a hard disk, or the like. The permission information setting unit 106 and the print data search unit 108 are realized by the CPU by controlling the respective units of the print server 10 according to an instruction contained in a program stored in the memory, the hard disk, or the like. The above-described program may be presented by being stored in a CD-ROM, a DVD-ROM, a flash memory, or any other information storage media in any format, and read by a medium reader connected to the print server 10, whereby the program is read from the information storage medium. Alternatively, the program may be downloaded via a network.

The communication unit 100 exchanges data between the client device 20 and the printer 30. As described above, the communication unit 100 is realized by a network interface, for example, by communicating using the TCP/IP protocol.

The user information memory 102 memorizes a representative of each user. The representative of the user can be given authority to output via the printer 30 the print data belonging to, or owned by, the user. The print data owned by the user is print data produced in a client device 20 operated by the user and sent to the print server 10. As described above, the user who owns print data is referred to as the owner of the print data. Information about a print data owner is stored in the header portion of the print data.

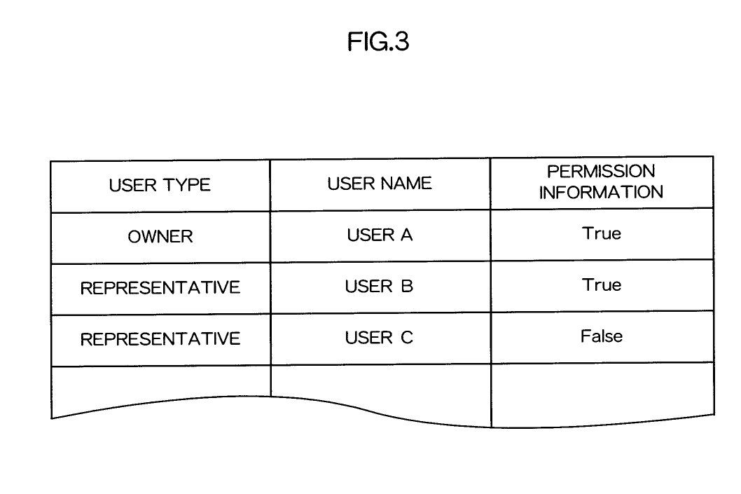

FIG. 3 shows one example of a representative setting table stored in the user information memory 102. A representative setting table is an information table which shows a representative of each user in association with the user.

As shown in FIG. 3, the representative setting table shows, in a mutually associated manner, the user name of the owner of print data and permission information describing whether or not output of the print data to the owner is permitted. In general, output of print data by the owner thereof is permitted, though the output can be prohibited depending on a situation. The permission information is expressed using a one-bit true/false value with, for example, “True” indicating permission and “False” indicating prohibition.

The representative setting table additionally shows, in a mutually associated manner, the user name of a representative of a print data owner and permission information describing whether or not output of the print data by the representative is permitted. The representative setting table may include more than two representative names or no representative name with respect to a single user. The representative setting table is prepared for each user and stored in the user information memory 102.

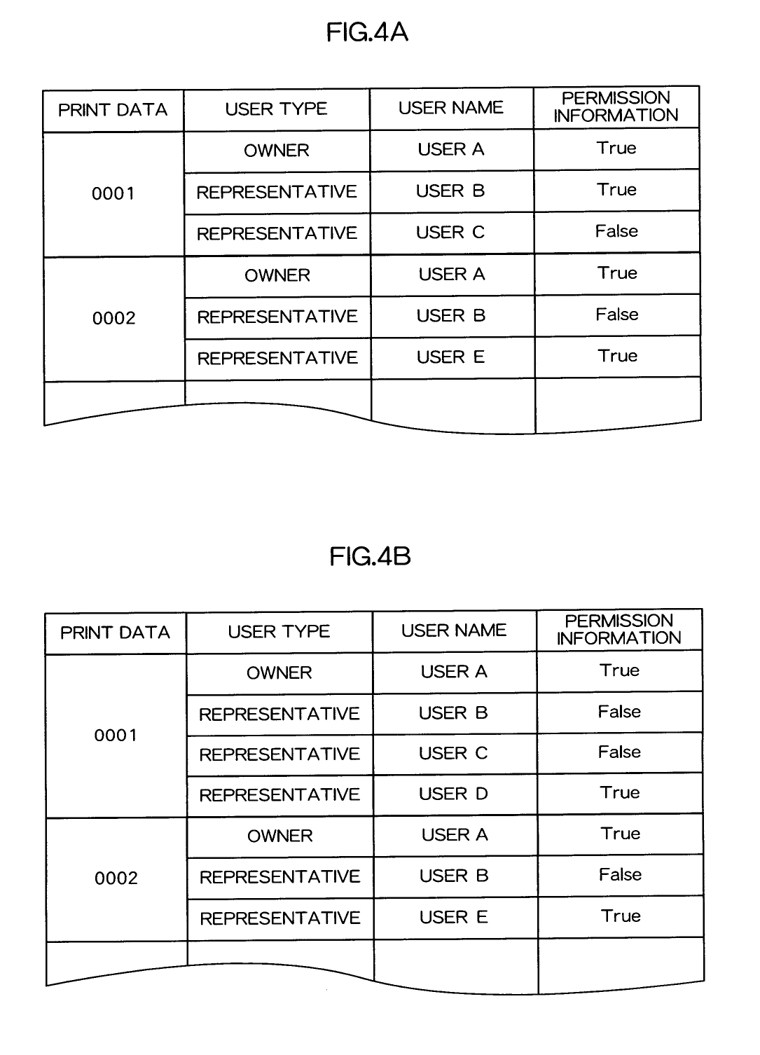

The print data memory 104 stores print data and information about the owner of the print data and their representative. FIG. 4 shows one example of a print information table stored in the print data memory 104. The print information table is an information table which shows, for every item of print data, the owner of the print data, their representative, and permission information of each of the owner and their representative, all being associated with one another.

Specifically, the print information table shows print data ID for identifying print data, or information to be processed, the user names of the print data owner and their representative, and permission information describing whether or not output of the concerned print data is permitted with respect to each user, all being associated with one another.

The print information table, stored in the print data memory 104, is produced based on the data shown in the representative setting table, stored in the user information memory 102. That is, the initial value shown in the print information table is determined based on the value shown in the representative setting table. For example, suppose that print data produced in the client device 20 operated by the “user A” is transmitted to the print server 10. The print server 10, with reference to the header portion of the print data, specifies the owner of the received print data as the “user A”, and then, with reference to the representative setting table for the “user A”, sets the “user B” and the “user C” as representatives of the “user A”, and includes this information in the print information table.

The respective values shown in the print information table may thereafter be changed. FIG. 4B shows the print data “0001” having been updated from that shown in FIG. 4A. That is, in FIG. 4B, in connection with the print data “0001”, the permission information for the “user B” is changed, and the “user D” is newly added as a representative. Change of a value shown in the print information table is effected by the permission information setting unit 106 to be described below.

That is, the permission information setting unit 106 updates the data shown in the print information table, and when accessed by the client device 20, sends display information to the client device 20 via the communication unit 100 so that the information included in the print information table can be reviewed. The display information may be produced using, for example, a publicly known language, such as HTML, or the like. In the above, the permission information setting unit 106 may send the display information to the client device 20 only when the client device 20 is authenticated as a user. Moreover, the display information to be sent may contain a print information table showing the print data owned by the authenticated user.

Thereafter, the client device 20 selects a data item to be updated from among those shown in the displayed print information table, and, according to a user input, updates the selected item, such as the user name of the representative, the permission information with respect to the owner or the representative, and so forth. The above-described update includes, for example, addition of a new representative to the print information table.

Here, the print data search unit 108 operates as follows upon receipt, via the communication unit 100, of the user name which is authenticated by the authentication server 40 based on the user information input to the printer 30, together with a request to transfer the print data to the printer 30. That is, the print data search unit 108 searches the print data memory 104 for a print information table, using the received user name as a search key, in order to search for print data permitted to be output in association with the received user name. One example of a print data search process in this exemplary embodiment will be described below.

That is, with reference to the print information table, stored in the print data memory 104, the print data search unit 108 searches for, and retrieves, the ID of the print data shown therein as permitted to be output to the user having the user name received, and then reads the print data from the data memory 104 based on the ID of the retrieved print data. Thereafter, the print server 10 transfers the read print data to the printer 30 via the communication unit 100.

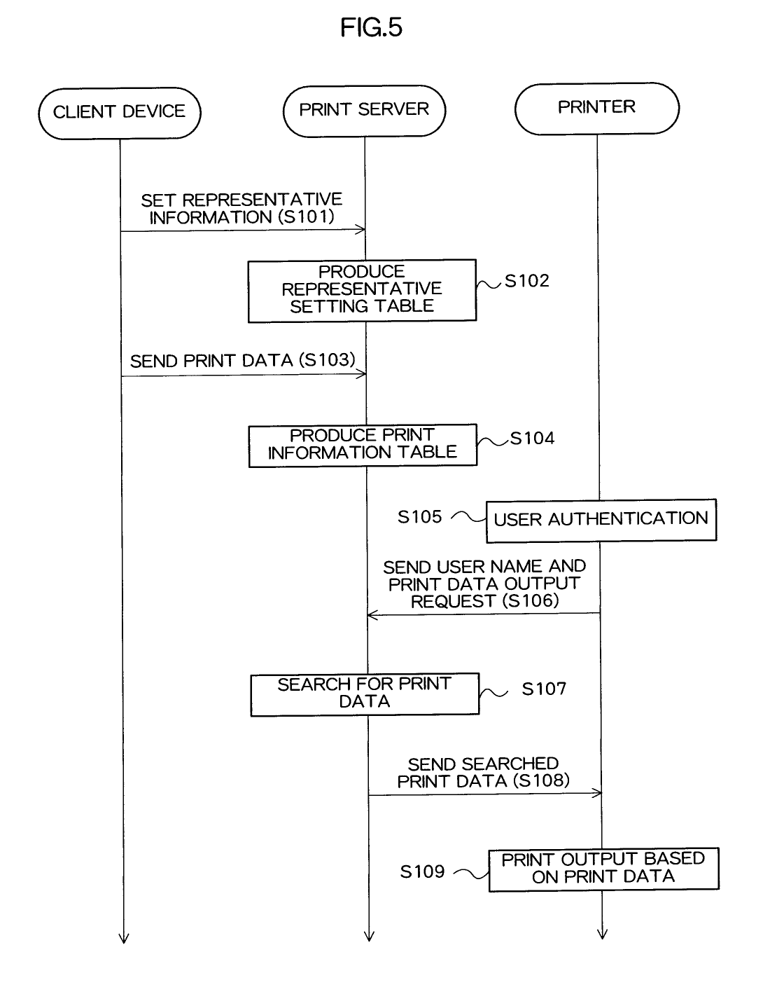

In the following, with reference to the sequential diagram shown in FIG. 5, outputting of the print data by the print system 1 will be described.

Initially, the client device 20 accesses the print server 10 to register representative information of the user (S101). In this exemplary embodiment, specifically, the user operating the client device 20 inputs information about their representative into the print server 10.

Thereafter, the print server 10 produces a table for setting a representative of the user, or a representative setting table, based on the representative information received from the client device 20 (S102). The produced representative setting table is stored in the user information memory 102.

With a print request received from the user, the client device 20 produces print data based on application data, or the like, and sends the produced print data to the print server 10 (S103).

The print server 10 receives the print data from the client device 20, and produces a print information table based on the received print data and the representative setting table stored in the user information memory 102 (S104). That is, the print information table is produced based on the information about the print data owner and their representative, shown associated with the owner in the representative setting table.

Here, a process to request print output, the process carried out by a user operating the printer 30, will be described.

Initially, the user inputs user information into the printer 30. Thereupon, the printer 30 requests the authentication server 40 to carry out authentication based on the user information input (S105), and requests the print server 10 to output the print data accumulated therein, while sending the user name of the authenticated user to the print server 10 (S106). In the above, the user authentication may be carried out using various types of authentication methods, such as password authentication, biometrics, IC card authentication, or the like, or a combination thereof.

The print server 10 receives the user name from the printer 30, and then, while using the received user name as a search key, searches for, and retrieves, print data permitted to be output to the user having the received user name in the print information table, stored in the print data memory 104 (S107). In the above, the print data permitted to be output to the user as the owner of the print data or the representative of the owner is retrieved.

Thereafter, the print server 10 sends the retrieved print data to the printer 30 (S108). In the above, with two or more items of print data retrieved, the print server 10 collectively or sequentially, after dividing, sends the plural items of print data to the printer 30.

The printer 30 receives the print data sent from the print server 10, then produces image based on the received print data, and forms the image on a print sheet for output (S109).

In the following, a modified example of this exemplary embodiment will be described.

The representative setting table in the user information memory 102 and the print information table in the print data memory 104 can be directly updated by the client device 20 by accessing the print server 10 and inputting information for update. Alternatively, the table may be updated as follows, rather than being updated directly.

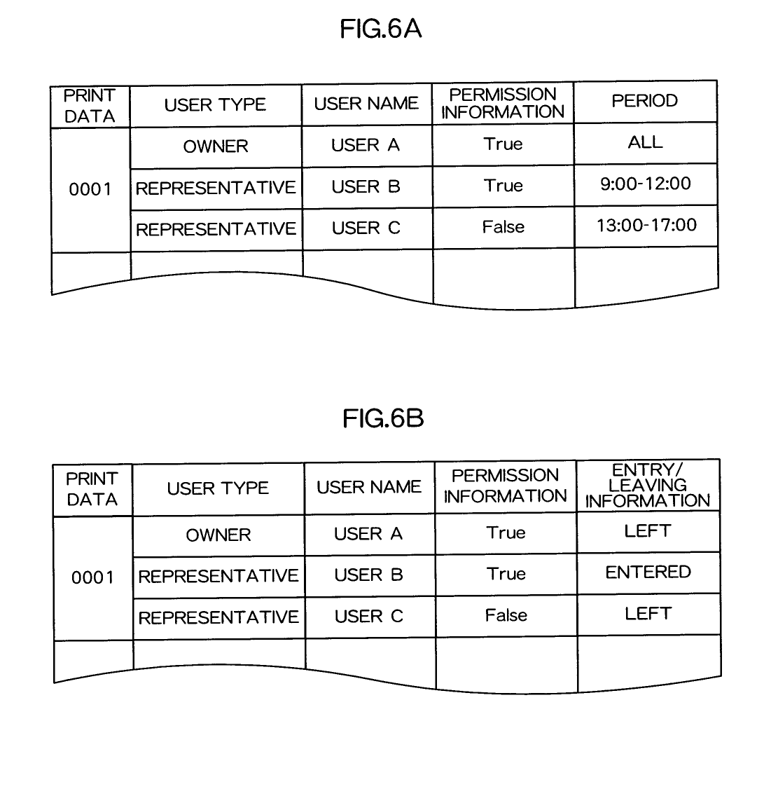

For example, with reference to each user's permission information and situation permission information which depends on a time, a date, or a period, the print server 10 may determine whether or not output of the print data to the user is permitted, and update the value in the table based on the determination result. Situation permission information is used in determining whether to permit output of the relevant data to the concerned user depending on a situation. In the following, the situation permission information will be described with reference to FIG. 6A.

As shown in FIG. 6A, the print information table shows a period of time with data output permitted with respect to each representative. The print server 10, when used by the owner or their representative, determines whether or not to permit output of print data to the user, based on the period information shown in the print information table and the permission information for the user.

Specifically, with the print server 10 operating based on the print information table shown in FIG. 6A, the following results. That is, with respect to the “user A”, or the owner of the print data, data output is always permitted. With respect to the “user B”, or the representative of the owner, output of the requested print data is permitted only when the request is made during “9:00 to 12:00”, but not in any other period of time. With respect to the “user C”, another representative of the owner, data output is not permitted at all, despite the description in the table permitting data output to the “user C” during “13:00 to 17:00”, because the permission information “False” is set for the “user C”. It should be noted that designation of a period of time when data output is permitted to the owner and each representative may be made based not only on a period of time, as described above, but also on a day of the week, a date, or the like.

The print server 10 may perform determination as to whether or not to permit output of print data to a user having requested the output, based on the permission information of the user and the situation permission information depending on whether or not the user is available, and update the value in the table based on the determination result. FIG. 6B shows one example of a print information table including the situation permission information. Here, availability of the user concerns whether or not the user is in a place, such as an office, where the user can instantly obtain the printed matter output from the printer 30.

Whether or not the user is available may be determined based on entry/leaving information of the user, which is managed by an entry/leaving management server. The entry/leaving management server has a database for managing the entry/leaving information of each user based on the information read from their IC card every time the user enters or leaves the office. The print server 10 accesses the entry/leaving management server to obtain the user's entry/leaving information from the database held by the entry/leaving management server. With the obtained user's entry/leaving information indicating “left”, the print server 10 may permit output of the print data owned by the user to at least some of the representatives designated as their representatives in the print information table for the user. Then, with the user's entry/leaving information indicative of “entered” obtained thereafter, the print server 10 may control so as to prohibit output of the print data to any of their representatives shown in the print information table for the user.

That is, with an arrangement such that print data output to the representative of the print data owner is permitted only when the owner is not available, or has “left”, a request to output the print data is processed as follows.

That is, with reference to with FIG. 6B, a request to output print data “0001” made by the “user B”, or the representative of the owner of the print data “0001”, is permitted as the “user A” is in the “left” state. However, with the “user A” returning, with their entry/leaving information accordingly changing to “entered”, the request by the “user B” is no longer permitted. Besides, the print server 10 may be controlled so as to prohibit output of print data to a user with the entry/leaving information “left” despite permission information “True” set for that user.

Alternatively, whether or not the user is available may be determined based on whether or not the user has logged in the computer system. That is, the print server 10 updates the permission information for a representative of the user based on the user's computer log-in state. In this case, the print server 10 may access the management server for managing the computer log-in state, and, with the user not logged in, output of print data owned by the user to at least some of their representatives shown in the print information table may be permitted. Meanwhile, with the user having logged in, the information in the print information table for the user may be updated so as to prohibit output of the print data owned by the user to any of their representatives shown therein.

Alternatively, the print server 10 may permit or prohibit print data output to a user, depending on the time elapsed after reception of the print data. Specifically, the printer server 10 records the time at which print data is received form the client device 20, and, with a predetermined period of time having elapsed, may permit output of the print data to at least some of the representatives shown in the print information table. The period of time that needs to elapse before permitting the output may be determined for every item of print data. The time elapsing may be measured from the time at which the client device 20 sends the print data.

Alternatively, the print information table may additionally show the maximum number of times at which print data output to the print data owner or each of their representatives can be permitted, so that when the number of times the print data is output to the print data owner or their representatives exceeds the maximum number of times, the print server 10 may no longer send the print data to the printer 30.

It should be noted here that, although the printer 30 and the authentication server 40 are separate entities connected to each other via the network 50 in the above-described exemplary embodiment, the user authentication function, assigned to the authentication server 40 in the above, may be assigned to the printer 30, so that a separate authentication server is no longer necessary.

The present invention is not limited to the above-described exemplary embodiment. Obviously, the present invention has wide application to systems for distributing electronic documents accumulated in a server device to an information processing device connected via a network to the server device, when the user authenticated by the information processing device is the owner of the electronic document or their representative.

What is claimed is:

1. An information processing device, comprising:
a storage unit that stores job data to be processed;
a permission information memory that stores, for every item of the job data stored in the storage unit, permission information describing whether or not output of the job data is permitted with respect to a user that owns the job data and a representative of the user;
a search unit that searches, when receiving from a device a request to output the job data stored in the storage unit and user identification information identifying a user, for job data permitted to be output by the user based on the user identification information and the permission information; and
a transfer unit that transfers the job data searched for by the search unit to the device.

2. The information processing device according to claim 1, further comprising:
a representative memory that stores, for every user that owns the job data, information of at least one representative of the user.

3. The information processing device according to claim 1, wherein the permission information memory further stores situation permission information for controlling output of the job data depending on a situation at a time of use, and the search unit searches, when receiving from the device the request to output the job data stored in the storage unit and the user identification information identifying the user, for the job data permitted to be output by the user based on the user identification information, the permission information, and based on the situation permission information.

4. The information processing device according to claim 3, wherein the situation permission information is information for controlling output of the job data with respect to each user depending on a period of time.

5. The information processing device according to claim 3, wherein the situation permission information is information for controlling output of the job data depending on whether or not the user that owns the information is absent.

6. The information processing device according to claim 3, wherein the job data stored in the storage unit is job data received from a terminal device, and the situation permission information is information for controlling output of the job data depending on a period of time elapsed after reception of the job data from the terminal device.

7. The information processing device according to claim 1, further comprising:
a permission information changing unit that changes the permission information stored in the permission information memory so as to permit or prohibit output of the job data with respect to each user.

8. A control method for an information processing device, comprising:
storing job data to be processed;
storing, for every item of the stored job data, permission information describing whether or not output of the job data is permitted with respect to a user that owns the job data and a representative of the user;
searching, when receiving from a device a request to output the job data stored and user identification information identifying a user, for job data permitted to be output by the user based on the user identification information and the permission information; and
transferring the job data searched for to the device.

9. The control method for an information processing device according to claim 8, further comprising:
storing, for every user that owns the job data, information of at least one representative of the user.

10. The control method for an information processing device according to claim 8, further comprising:
storing situation permission information for controlling output of the job data depending on a situation at a time of use; and
searching, when receiving from the device the request to output the stored job data and the user identification information identifying the user, for the job data permitted to be output by the user based on the user identification information, the permission information, and based on the situation permission information.

11. The control method for an information processing device according to claim 10, wherein the situation permission information is information for controlling output of the job data with respect to each user depending on a period of time.

12. The control method for an information processing device according to claim 10, wherein the situation permission information is information for controlling output of the job data depending on whether or not the user that owns the information is absent.

13. The control method for an information processing device according to claim 10, wherein the stored job data is job data received from a terminal device, and the situation permission information is information for controlling output of the job data depending on a period of time elapsed after reception of the job data from the terminal device.

14. The control method for an information processing device according to claim 8, further comprising:
changing the permission information stored so as to permit or prohibit output of the job data with respect to each user.

15. A program recording medium storing a program causing a computer to execute a function comprising:
storing job data to be processed;
storing, for every item of the stored job data, permission information describing whether or not output of the job data is permitted with respect to a user that owns the job data and a a representative of the user;
searching, when receiving from a device a request to output the job data stored and user identification information identifying a user, for job data permitted to be output by the user based on the user identification information and the permission information; and
transferring the job data searched for to the device.

16. The program recording medium according to claim 15, the function further comprising:
storing, for every user that owns the job data, information of at least one representative of the user.

17. The program recording medium according to claim 15, the function further comprising:
storing situation permission information for controlling output of the job data depending on a situation at a time of use; and
searching, when receiving from the device the request to output the stored job data and the user identification information identifying the user, for the job data permitted to be output by the user based on the user identification information, the permission information, and based on the situation permission information.

18. The program recording medium according to claim 17, wherein the situation permission information is information for controlling output of the job data with respect to each user depending on a period of time.

19. The program recording medium according to claim 17, wherein the situation permission information is information for controlling output of the job data depending on whether or not the user that owns the information is absent.

20. The program recording medium according to claim 17, wherein the stored job data is job data received from a terminal device, and the situation permission information is information for controlling output of the job data depending on a period of time elapsed after reception of the job data from the terminal device.

21. The program recording medium according to claim 15, the function further comprising:
changing the permission information stored so as to permit or prohibit output of the job data with respect to each user.

22. An output processing system, comprising:
a terminal device,
an output processing device, and
an output device,
wherein
the terminal device includes a transmission unit that transmits job data to the output processing device,
the output processing device includes
a receiving unit that receives the job data transmitted from the transmission unit,
a storage unit that stores the job data received by the receiving unit, and
a permission information memory that stores, for every item of the job data stored in the storage unit, permission information describing whether or not output of the job data is permitted with respect to a user that owns the job data and a representative of the user,
the output device includes a request unit that transmits to the output processing device user identification information identifying a user and a request to output the job data stored in the storage unit, and
the output processing device further includes
a search unit that searches for job data permitted to be output by the user based on the user identification information transmitted together with the request from the request unit, and the permission information, and
a transfer unit that transfers the job data searched for by the search unit to the output device.
